(19) United States
(12) Patent Application Publication
(10) Pub. No.: US 2012/0291572 A1
(43) Pub. Date: Nov. 22, 2012

(54) Baker Torcor motion conversion mechanism

(76) Inventors: James Michael Baker, Niles, MI (US); Brent Michael Baker, Niles, MI (US); Brandon Joseph Baker, Brownsburg, IN (US); Deborah Bryanne Foreman, South Bend, IN (US)

(21) Appl. No.: 13/506,772

(22) Filed: May 16, 2012

Related U.S. Application Data
(60) Provisional application No. 61/519,170, filed on May 18, 2011.

(51) Int. Cl. F16H 19/04

(52) U.S. Cl. 74/32; 74/29

(57) ABSTRACT

The present invention utilizes a series of uniquely timed gears and flywheel(s) to convert a linear motion into a rotary motion or a rotary motion into a linear motion. The movement of the drive component (linear or rotary) results in an exact mathematical movement of the driven component (rotary or linear), divided by or multiplied by its gear ratio and can be measured at any point of the stroke or angle of rotation. The present invention achieves and maintains the mathematically and mechanically optimum 90 degree relationship between the linear and rotary components through the entire linear stroke and rotary motion, thereby eliminating the inefficient geometric constraints of a variable vector, crankshaft based motion conversion mechanism.

This U.S. Patent Application is a continuation of and claims priority from U.S. Provisional Patent Application No. 61/519,170 filed May 18, 2011, the entirety of which is fully incorporated by reference herein.

### FIELD OF INVENTION

The subject invention generally relates to work machines, and, in particular, a work machine mechanism to provide an improved means of converting rotary motion to linear motion or linear motion to rotary motion. The present invention solves the inefficient angular relationship problem which exists between the linear and the rotary components of a crankshaft based work machine and is a general improvement over existing motion conversion mechanisms.

By design, a crankshaft has inherently poor torque advantage limitations which forever limit the efficiency gains that can be achieved in any crankshaft based application, most notably an internal combustion engine.

The present invention achieves a set stroke or rotation in a positive, constant rate and square torque advantage fashion by utilizing a series of uniquely timed gears and flywheel(s) to convert a linear motion into a rotary motion or a rotary motion into a linear motion.

The present invention achieves and maintains the mathematically and mechanically optimum 90 degree relationship between the linear and rotary components through the entire linear stroke and rotary motion, thereby eliminating the inefficient geometric constraints of a variable vector, crankshaft based motion conversion mechanism.

It will become clear and evident by these teachings that the present invention provides real and meaningful improvement to the current state of the art in motion conversion mechanisms.

### RELATED ART

The vast majority of internal combustion engines use a crankshaft to convert a pistons linear motion to a rotary motion. Combustion efficiency and crankshaft geometry affects overall engine efficiency. Combustion efficiency is at its maximum when combustion pressure is at its peak. In crankshaft based engines, this occurs at a very inefficient degree of crankshaft rotation.

For example, during the power stroke of a four stroke OTTO cycle engine, the peak pressure developed in the combustion chamber is generally achieved at a point where the crankshaft axial centerline is only a few degrees after top dead center (ATDC) for the particular cylinder. This causes the effective torque arm of the crankshaft to be reduced to mere fractions of an inch. Due to the crankshafts fixed geometry, there cannot be an increase in the length of the crankshafts torque arm. This basic design flaw severely limits the efficiency of the entire assembly.

There have been many inventions which have been commercially developed to increase the efficiency of the crankshaft based internal combustion engine including, but not limited to, fuel injection, electronic sensors and actuators, computerized engine management systems, supercharging, turbo charging, improved intake and exhaust valves and porting, etc.

Additional inventions which have tried to address the primary concerns of the present invention include, but are not limited to, the rotary engine, orbital engines, opposed piston engines, multiple crankshaft engines, etc.

There are many other inventions that have taught the use of dual crankshafts in order to change the compression ratios and alignment angles of the piston in the cylinder bore by using complex dual crankshaft phase control systems to alter the angular relationships of the linear and rotary components to increase efficiency.

For example, U.S. Pat. No. 5,595,147 issued Jan. 21, 1997 (Feuling) proposes two contra rotating crankshafts with multiple connecting rods to balance an engine and reduce piston to cylinder wall friction to improve performance and increase durability. Feuling's patent uses two crankshafts, both of which suffer from the same inefficient geometry problems described herein and is therefore in need of improvement.

Additional examples of engines which incorporate dual crankshafts are cited, such as U.S. Pat. No. 5,058,536 issued Oct. 22, 1991 (Johnson), U.S. Pat. No. 7,032,385 issued Apr. 25, 2006 (Gray Jr.) and U.S. Pat. No. 7,584,724 issued Sep. 8, 2009 (Berger), and all are included in their entirety herein by reference.

U.S. Pat. No. 5,732,673 issued Mar. 31, 1998 (Mandella) provides for three crankshafts located in an engine block. This arrangement provides a variable stroke, variable compression ratios and reduced cylinder wall to piston friction. This complicated mass of connecting rods and crankshafts could prove to be difficult to manufacture and produce in volume, and its complexity would leave many mechanics baffled. Mandella does not teach a simple and cost effective solution to achieving the desired effect of having a consistent 90 degree angle relationship between the linear and the rotary component during the entire length of the linear components travel.

U.S. Pat. No. 5,537,957 issued Jul. 23, 1996 (Gutkin) is an internal combustion engine which has no conventional crankshaft, but rather a plurality of levers and gears to convert the linear motion of the moving piston to rotational motion of a central shaft, which in itself performs the basic functions of a crankshaft. The problem with Gutkin's teachings is the complexity of the moving levers, arms, hinges and other mechanisms to accomplish the desired task. And even though Gutkin's peak pressure is acting upon the lever and crank system at the optimum 90 degree angle at one exact moment, the angle is quickly lost due to the rotating modified crank and lever assembly and does not maintain the angle squarely throughout the entire travel of the linear stroke.

Further, Gutkin does not actually solve the fundamental problem of crankshaft geometry in relation to peak cylinder pressure, nor does Gutkin optimize the energy transfer in a positive, constant rate and square torque advantage fashion, and is therefore subject to similar crankshaft torque arm and transfer of torque limitations as described herein.

Each of the above cited patents, and many others which are not cited for the sake of brevity, utilize multiple crankshafts, variable compression ratios and variable crankshaft phase controls to increase fuel efficiency, decrease emissions and in some cases reduce the side to side friction between the piston and cylinder wall during the pistons linear travel in the cylinder bore.

And while all of these inventions have their merits and do raise engine efficiencies somewhat, they are all incremental improvements in efficiency which cannot be implemented easily and cost effectively in mass production because they all add layers of complexity to the design and increase manufacturing costs. Also, they do not actually address and solve the fundamental problem associated with a crankshafts fixed geometry in relation to peak cylinder pressure. All of these patented improvements are subject to the same crankshaft torque arm limitations.

In a motion conversion device that may be considered similar to the present invention, the “enclosed elliptical rack and pinion reciprocating mechanism” has a shaft mounted rotating input gear having teeth on only a part of its circumference (greater than 90 degrees) and rotates in a fixed position inside an enclosed ellipse which has teeth on its inside face above and below the rotary gear. As the gear rotates clockwise in its fixed position, the teeth on the gear mesh with the upper teeth on the inside edge of the ellipse causing the ellipse to travel in a linear direction to the right. When the clockwise rotating gear teeth disengages from the upper rack gear teeth and engage the lower rack gear teeth, the teeth on the gear mesh with the lower teeth on the inside edge of the ellipse causing the ellipse to travel in a linear direction to the left. This left and right linear travel will continue as long as the input gear rotates.

The enclosed elliptical rack and pinion reciprocating mechanism can only be used for rotary to linear conversion, and cannot be used to convert linear to rotary due to the geometry of the mechanism and the engagement, disengagement and clearance issues associated with the gear. Further, due to design limitations, enclosed elliptical rack and pinion reciprocating mechanisms cannot provide advantageous torque increases or decreases that result in an exact mathematical movement of the drive component (rotary), divided by or multiplied by its gear ratio that can be measured at any point of the stroke or angle of rotation, as is provided by the present invention.

In light of the above described state of the art, and the known and obvious need for improvement to any and all crankshaft based mechanisms, it is the intent of the present invention to provide a simple and cost effective alternative to the centuries old variable vector crankshaft used in motion conversion mechanisms. The present invention solves the inefficient angular relationship problem which exists between the linear and the rotary components of a crankshaft based work machine and increases the efficiency of any machine or device which uses said present invention instead of a conventional crankshaft.

It is also the intent of the present invention, in an internal combustion engine embodiment, to provide a means to increase fuel efficiency, reduce piston to cylinder wall bore friction and side loads and to eliminate the crankshaft from the engine altogether. The invention of such a mechanism is of special significance and importance to costs, energy efficiency and pollution reduction.

It is also the further intent of the present invention, in a pneumatic pump and/or motor embodiment, to provide a means to increase operational efficiency, reduce piston to cylinder wall bore friction and side loads, and to eliminate the crankshaft from the assembly altogether. The invention of such a mechanism is of special significance and importance to increase energy efficiency, reduce wear while increasing durability, and simplify the overall design.

It is also the additional intent of the present invention, in a hydraulic pump/motor embodiment, to provide a means to increase pumping and motoring efficiency, reduce piston to cylinder wall bore friction and side loads by providing a mechanism to convert a pistons linear motion into a rotary motion and/or a rotary motion into a linear motion. The invention of such a mechanism is of special significance and importance to increase energy efficiency, reduce wear while increasing durability, and simplify the overall design.

It is also an additional intent of the present invention, in an electric motor/generator embodiment, to provide a means to produce electrical energy through linear generators being driven by a rotary prime mover and/or provide a means to produce electrical energy though the rotary output of the present invention when the present invention itself is the prime mover by providing a mechanism to convert linear motion into a rotary motion and a rotary motion into a linear motion. The invention of such a mechanism is of special significance and importance to increase energy efficiency, reduce wear while increasing durability, and simplify the overall design.

Additionally, it is another intent of the present invention to bring the combustion chambers peak pressure point to a more advantageous position wherein a torque arm is of a greater length than previously attainable and thereby increase the engines overall operating efficiency.

Additionally, it is still yet another intent of the present invention to reduce or eliminate some of the electronic and electromechanical devices required in a modern ICE engine including, but not limited to, timing advance systems, knock or ping sensors, Manifold Absolute Pressure (MAP) Sensors, and others as the present invention may not require the use of said devices in particular applications.

The present invention, and its novelty and uniqueness, will be better understood when the attached drawings are viewed along with the operational descriptive text being read. These teachings will lead to an understanding of the principals of operation, the significance of the improvements the present invention brings to the state of the art in motion conversion mechanisms, and an understanding of the spirit and scope of the present invention beyond the limited space and limited embodiments presented and described herein.

### BACKGROUND OF THE INVENTION

The present invention solves the inherently inefficient angular relationship problem in a crankshafts design by providing a means to convert one motion type to another while maintaining the mathematical and mechanical optimum 90 degree relationship between the components.

It is clearly noted and understood that the present invention is primarily a mechanism, with attributes that are applicable across a wide range of applications, machines and devices. The present invention provides a mechanical advantage efficiency improvement over the current state of the art, in all applications and not just the internal combustion engine, which is the preferred embodiment of the present invention.

There are many linear to rotary conversion mechanisms which have been invented and used on countless machines to do work. Most rely on some sort of crankshaft derived device or fulcrum geometry which inherently has the same torque arm limitation problem which is described herein.

The present invention utilizes a series of uniquely timed gears and flywheel(s) to convert a linear motion into a rotary motion or a rotary motion into a linear motion. The movement of the drive component (linear or rotary) results in an exact mathematical movement of the driven component (rotary or linear), divided by or multiplied by its gear ratio and can be measured at any point of the stroke or angle of rotation.

There is no variable rate of mechanical advantage as provided by crankshaft based mechanical advantage mechanisms. The present invention provides optimum efficiency over a longer period of time, increased torque, improved reliability and reduced complexity and cost when compared to other crankshaft based mechanical advantage machines available today.

The invention of the external combustion engine, the piston steam engine and the subsequent invention and proliferation of the crankshaft based internal combustion engine (ICE) have had nothing short of a profound impact on humanity and the evolution of mankind. It is the low efficiency in the ICE crankshaft design that is the basis for the present invention and the improvements presented herein.

The ICE is a machine wherein the combustion of fuel (such as gasoline or diesel) and an oxidizer (usually air) occurs in a closed combustion chamber. The exothermic expansion of the gases produced by said combustion applies a direct force upon some moving component of the engine, such as a piston. This force moves the piston over a fixed distance to convert the useable energy for work.

Examples of ICE machines are the two stroke engine, the four stroke engine, and some variants like the Wankel rotary engine. Today, the most common crankshaft based ICE is of the four stroke design. The four stroke configuration was invented in 1867 by Nikolaus Otto, and is referred to as the “Otto” cycle engine. The Otto cycle engine converts the potential chemical energy in a fossil fuel (or chemically derived fuel) into usable mechanical energy through a series of mechanical components, processes and precisely timed events based on the crankshaft, connecting rod and piston configuration of a modern internal combustion engine.

In the Otto four stroke ICE, there are four distinct operational steps, each performed in sequence, consisting of the intake stroke, the compression stroke, the combustion or power stroke and finally the exhaust stroke. The intake stroke introduces combustible fuels into a closed combustion chamber; the compression stroke pressurizes the air/fuel mix in the combustion chamber; the combustion stroke or power stroke ignites the pressurized gasses and the expanding gasses exert a force upon the piston, and finally the exhaust stroke, where the burned and cooled gasses are exhausted to atmosphere.

The piston is located in a cylinder bore where the pistons travel is linear. The piston is connected to the crankshaft by the connecting rod. The connecting rod can rotate at both ends so its angle can change relative to the pistons linear position and the crankshafts rotary position. The linear motion of the piston during the power stroke transmits the force of energy from combustion to the connecting rod, which then rotates the crankshaft.

Generally, the crankshaft is one solid piece of metal made from cast iron or forged steel. The rotational axis of the crankshaft runs through the centerline of the main journals. The main journals rotate in the main bearing bore cast into the engine block and secured with the main bearing journal caps. The connecting rod journals are where the connecting rods attach. The connecting rod journals circle around the crankshafts axis of rotation in an orbital fashion. The amount of torque they deliver is determined by the distance between the connecting rod journals center axis and the crankshafts center axis of rotation known as the “torque arm” (which may be measured in inches) and the angle between the vertical centerline of the crankshafts axis and the connecting rod journals center axis, which is usually figured at peak cylinder pressure during combustion and measured in degrees of rotation at the crankshaft. In multi cylinder designs, the connecting rod journals are designed so there is always at least one piston on the power stroke to aid in rotational momentum.

The crankshaft is situated longitudinally in the engine block, parallel to and directly below the piston(s) cylinder bore(s). This arraignment provides a simple and compact machine to convert the pistons linear motion to rotary motion at the crankshaft, which then transmits the energy to whatever device it is connected to in order to perform useful work. While this design works and has become inexpensive to produce, it is also its own Achilles heel, as the angular relationship of the piston, connecting rod and crankshaft is counterproductive to the efficient conversion and use of the available potential energy.

For example, the original steam engine employed a single, reciprocating piston design wherein the crankshaft was connected to the output shaft of the piston to convert the linear motion of the piston into rotary motion using an offset lever connecting rod to rotate the wheel. The poor vector angles produced by the angular geometry of the steam engine crankshaft during its rotation reduced the mechanical motion conversion efficiency.

Comparatively, today's crankshaft based Otto ICE machines still employ the same variable vector, low-efficiency crankshaft based energy transfer system where power and efficiency is lost due to the engineering shortcomings which inherently limits the mechanical motion conversion efficiency of these engines, even though the combustion of modern, highly atomized fuels in close tolerance combustion chambers burn at very high temperatures and pressures producing tremendous potential energy. This poor energy conversion efficiency is because of the following reasons.

First, the vector angle of the connecting rods axial centerline in relation to the crankshaft axial centerline, during the period of peak pressure in the cylinder, is generally 10 to 15 degrees after the piston has passed top dead center (measured at the crankshaft). At this peak pressure point there is very little mechanical advantage. It has been determined through many years of engine research and development that 10 to 15 degrees after top dead center is the preferred peak pressure point where a standard crankshaft based ICE runs best and makes the most torque and horsepower.

The normal ignition firing point (igniting the air/fuel mixture with spark plugs) on a standard crankshaft ICE to achieve peak torque is between 25 and 40 degrees before the piston has reached top dead center, and may be as much as 50 to 60 degrees before top dead center with some alcohol fuels. It takes between 35 degrees of crank rotation and sometimes up to 75 degrees of crank rotation for the igniting air/fuel mixture to reach peak pressure.

The standard crankshaft based ICE allows the ignition to be fired at this early point before top dead center because of the lack of a gainful mechanical torque arm advantage (or disadvantage) towards the top of the piston stroke. The main reasons for difference in the point at which you ignite the compressed air/fuel mixture is to keep peak pressure in the 10 to 15 degree range after top dead center are as follows:
1. Higher octane fuel burns slower than a lower octane fuel
2. The addition of oxidizers create a faster burning fuel
3. Fuel additives may speed up or slow down the rate of burn to peak pressure
4. Higher static compression ratios create a faster rate of burn
5. Lower static compression ratios create a slower rate of burn
6. Combustion chamber and shape which may promote more or less air/fuel cylinder filling
7. Intake and exhaust port flow and volume at or near designed peak torque
8. Intake and exhaust valve sizes and shape
9. Camshaft design including valve lift, duration, and overlap.

Another factor affecting the usable torque arm length at peak pressure is connecting rod ratio. Connecting rod ratio is the length of the connecting rod (in inches) divided by the stroke (in inches). Common rod ratios fall in the 1.4 to 1.8 range. A longer or shorter connecting rod will affect the torque arm angle and length at peak pressure, as a longer connecting rod will stay at top dead center (TDC) and bottom dead center (BDC) for a longer period of time than a shorter connecting rod.

Therefore, a longer connecting rod will have a shorter torque arm at peak pressure versus the shorter connecting rod. As the rod is shortened the side load on the piston and ring package as well as the load on the cylinder wall will increase dramatically, decreasing the mechanisms usable lifespan and the upper rpm range capability of a standard crankshaft ICE. Rapidly increasing side load as the rod is shortened limit's the engine designer's ability to gain a longer torque arm at peak pressure with a standard crankshaft type ICE.

As an example, the 12.5 degree vector angle shown in FIG. 1 will provide a torque arm of 0.325 inches (based on a 3 inch stroke ICE), giving a very poor mechanical torque arm advantage at peak pressure considering the potential mechanical advantage of a torque arm wherein the connecting rod and crankshaft were at a ninety degree angle to each other, which is considered mathematically and mechanically optimum.

Simply igniting the air/fuel mixture when the crankshaft/connecting rod angle is at ninety degrees or when the peak pressure will occur at ninety degrees is not a solution with a standard crankshaft type ICE. Even though the angular relationship is optimum at that point, the angle is immediately passed one crankshaft degree later and increasingly inefficient angles and torque arm lengths are encountered as the piston travels towards the bottom of the stroke.

Second, the air/fuel mixture is ignited before the piston reaches top dead center, thereby creating opposing forces between the exothermic expansion of the combusting air/fuel mixture in the cylinder and the compressive upward travel of the piston (aided by the crankshafts rotational momentum).

Additionally, the strength of the torque arm is determined by several factors including the octane ratings of the fuel, the amount of swirl in the incoming air/fuel mixture as the mixture is drawn in to the cylinder (or pushed into the cylinder in the case of turbo charging or super charging), combustion chamber design, piston dome to cylinder head design and clearances thereof, the compression ratio.

Higher compression ratios results in faster burning of the fuel mixture and increases pressure more rapidly meaning less time to start and complete the combustion process which, in turn, affects the ignition point. Also, camshaft design and lobe profile geometry will affect fuel flow rates, volumetric flow and efficiencies and the speed of combustion. These factors can result in an ignition point of 25 to 60 degrees before top dead center, causing the peak pressure to be realized at a highly inefficient and undesirable 10 to 15 degrees After Top Dead Center (ATDC), such as the 12.5 degree point as measured at the crankshaft and illustrated in FIG. 1 in the exampled ICE.

Also, the sudden motion stop and linear direction reversal at bottom dead center (the period of which is determined by the connecting rod length) would cause further efficiency reductions as the still expanding air/fuel mixture encountered brief compression when the piston began the upward stroke of the exhaust cycle, and then causing the combusting air/fuel mixture to exit the exhaust port when the exhaust valve opened, completely wasting the energy and reducing the overall efficiency to under 10 percent (10%).

The internal combustion engine has been the machine of choice for over a century to provide compact power to operate other machines, such as automobiles and electrical power generators. The crankshaft based ICE has gone through countless design and operational changes and refinements throughout its history, and, generally speaking, each design change and refinement has brought about cumulative improvements, with the goal being increased power with increased efficiency, and more recently, reduced emissions of unburned hydrocarbons.

The challenge continues to be to increase and optimize mechanical conversion efficiencies, simplify design and reduce cost. However, all of the inherent design flaws of the inefficient, competing and counterproductive mechanical forces of a crankshaft based mechanical advantage mechanism forever limit the efficiency increases to incremental improvements at best.

Until the angular relationship problem between the linear and the rotary can be addressed wherein the optimum ninety degree angle is not only achieved during the period of peak combustion pressure in the cylinder, but actually maintained throughout the entire useful combustion process, meaningful efficiency improvements will not occur.

### BRIEF DESCRIPTION OF THE DRAWINGS

FIG. 1 is an illustrative drawing of the conventional ICE crankshaft, piston and rod, and the 12.5 degree vector angle and 0.325 inch torque at peak pressure as provided by the example ICE, a Chevrolet 454 cubic inch gasoline V-8.

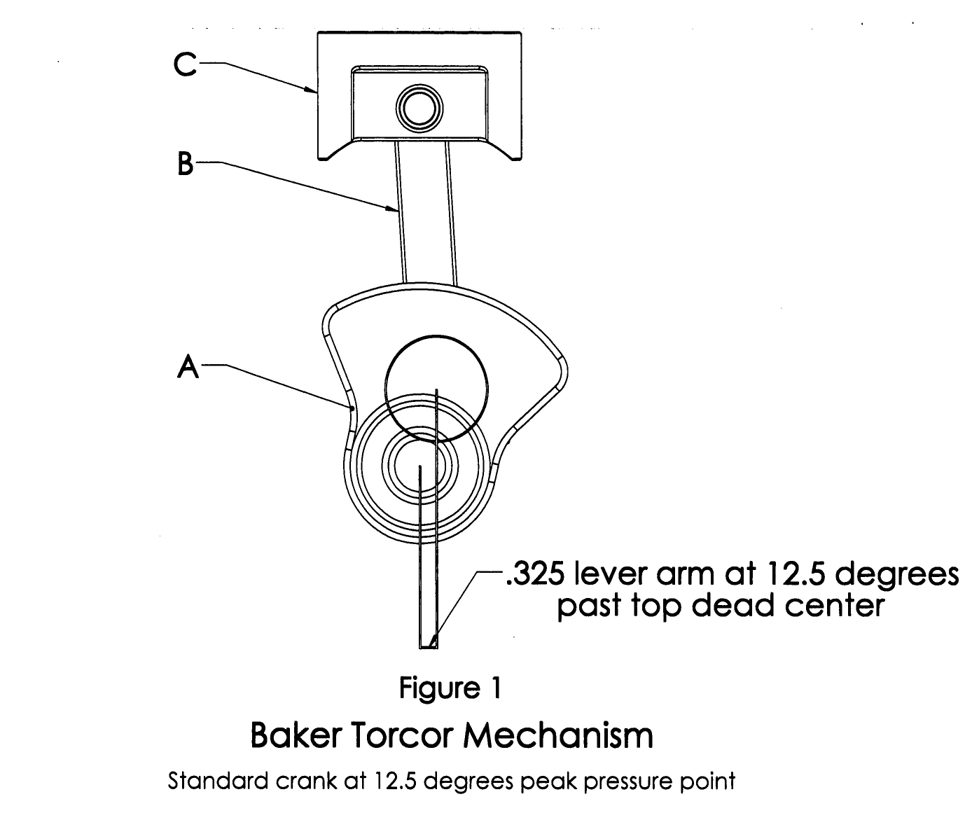

FIG. 2 is an illustrative drawing of the rack E and two front gears (D1 and D3) of the present invention, depicting the optimum ninety degree angular relationship between rack E and the torque transmitting gear D1 (and D3), showing D1 engaged and D3 not engaged.

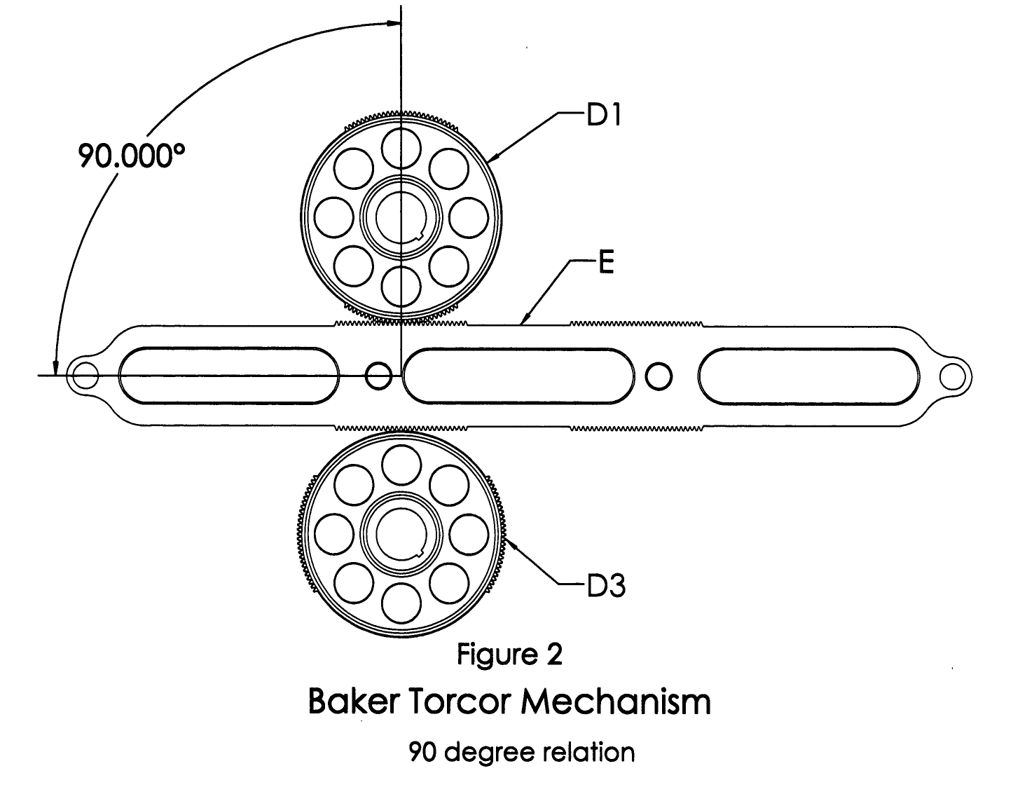

FIG. 3 is an illustrative drawing of the front gear set assembly showing rack E in a centered position and all front gears D1, D2, D3 and D4, showing D1 and D2 engaged and D3 and D4 not engaged.

FIG. 4 is an illustrative drawing of the back gear set showing gears C1, C2, C3 and C4, two center mesh gears labeled B1 and B2, and center gear A.

FIG. 5 is an illustrative drawing of flywheel J with horizontal marks depicting the grooved heart shaped tracking area and diagonal lines representing an area which may be removed for balancing purposes, and a keyed center hole is provided to facilitate rotational connection with the input/output shaft.

FIG. 6 is an illustrative drawing of one side of the case which may support gears and shafts for gears.

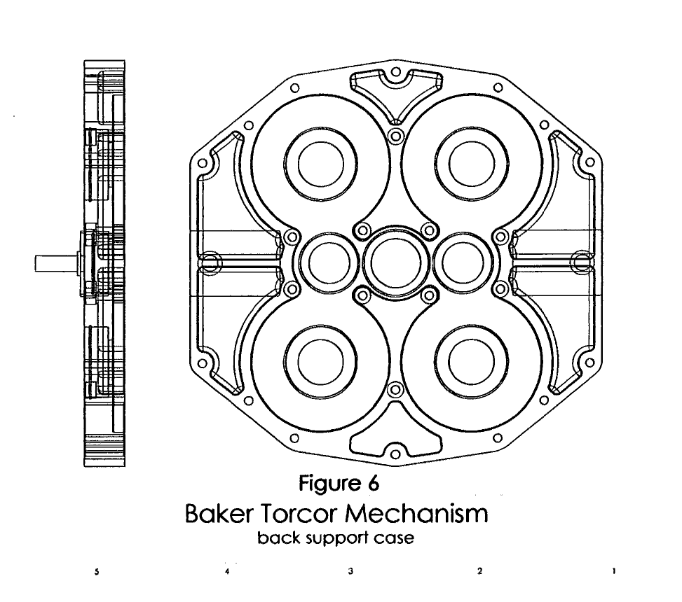

FIG. 7 is an illustrative drawing of the front case showing cutouts and bearing(s) H, showing front and side views.

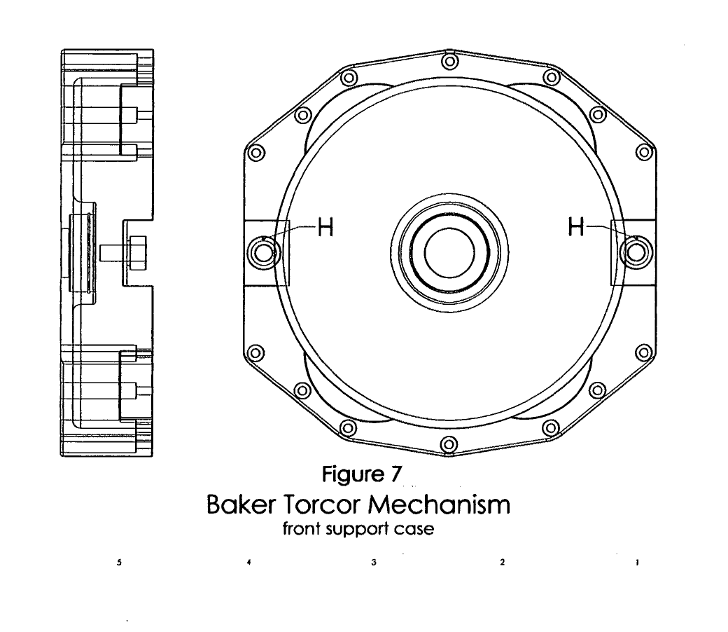

FIG. 8 is an illustrative drawing of the housings combined.

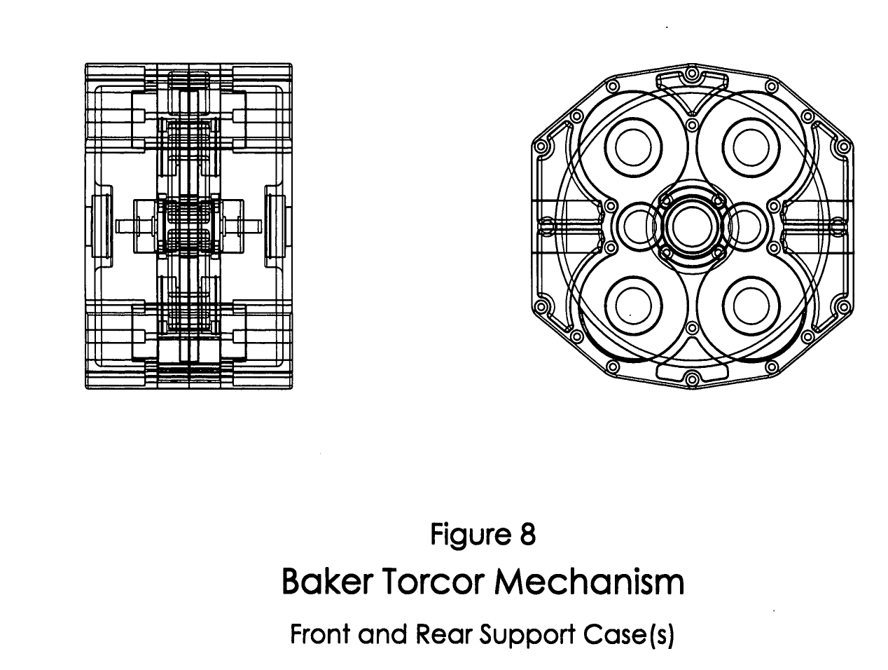

FIG. 9 is an illustrative drawing of the mechanism with pistons attached, such as those used on ICE machines, showing D1 and D2 engaged and D3 and D4 not engaged.

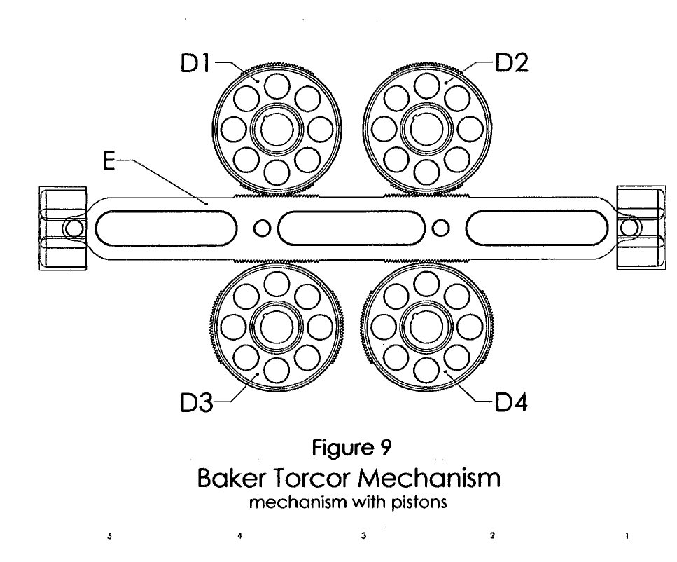

FIG. 10 is an illustrative side view drawing of the mechanism, showing D1 and D2 engaged and D3 and D4 not engaged, including the input/output shaft.

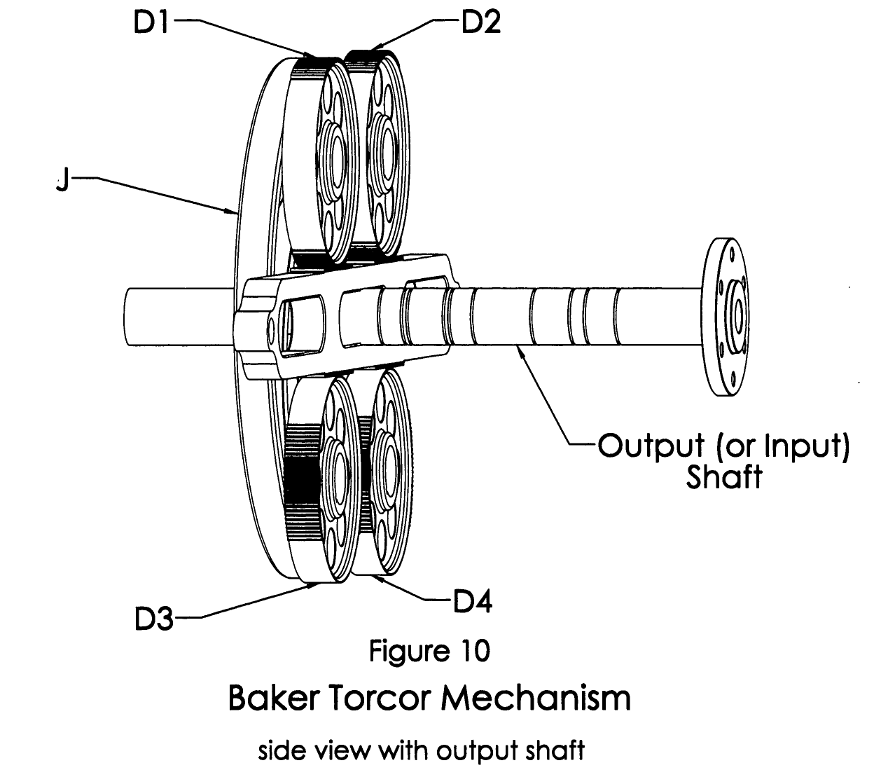

FIG. 11 is an illustrative drawing of the mechanisms front gear assembly at its furthest left point of travel showing D3 and D4 on the verge of engagement and D1 and D2 just disengaging. Note guide G is following the heart shaped tracing slot and flywheel and gear rotation is clockwise.

FIG. 12 is an illustrative drawing of the mechanisms front gear assembly progression as it travels to the right, showing D3 and D4 engaged and D1 and D2 disengaged and rack E is centered. Note guide G is following the heart shaped tracing slot and flywheel and gear rotation is clockwise.

FIG. 13 is an illustrative drawing of the mechanisms front gear assembly at its furthest right point of travel showing D1 and D2 on the verge of engagement D3 and D4 just disengaging. Note guide G is following the heart shaped tracing slot and flywheel and gear rotation is clockwise.

FIG. 14 is an illustrative drawing of the mechanisms front gear assembly progression as it travels to the left, showing D1 and D2 engaged and D3 and D4 disengaged and rack E is centered. Note guide G is following the heart shaped tracing slot and flywheel and gear rotation is clockwise.

FIG. 15 is an illustrative drawing of the mechanism in an alternative configuration with a four linear point dual rack, The back gear set becomes a shared center gearset and two flywheels are utilized, one on each side of the center shaft, as viewed from above.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention, in particular forms, but such exemplifications are not to be construed as limiting the scope of the invention in any manner.

### DETAILED DESCRIPTION OF THE PREFERRED EMBODIMENT

For the purposes of promoting an understanding of the principles of the invention, reference will now be made to the embodiment illustrated in the drawings, which will be described below. It will nevertheless be understood that no limitation of the scope of the invention is thereby intended or implied. The present invention includes any alterations and further modifications in the illustrated devices and described methods and further applications of the principles of the invention which would normally occur to one skilled in the art to which the present invention relates.

In the preferred embodiment, the present invention would prove to be of superior design and efficiency when compared to the conventional crankshaft based ICE machine. By changing the structural, mechanical and operational relationship between the components, the conversion of motion is optimized, as the vector angle achieves and maintains the mechanical and mathematically optimum ninety (90) degree relationship. The same is true for rotary to linear motion conversion. It will become clear and evident by these teachings that the present invention provides real and meaningful improvement to the preferred embodiment.

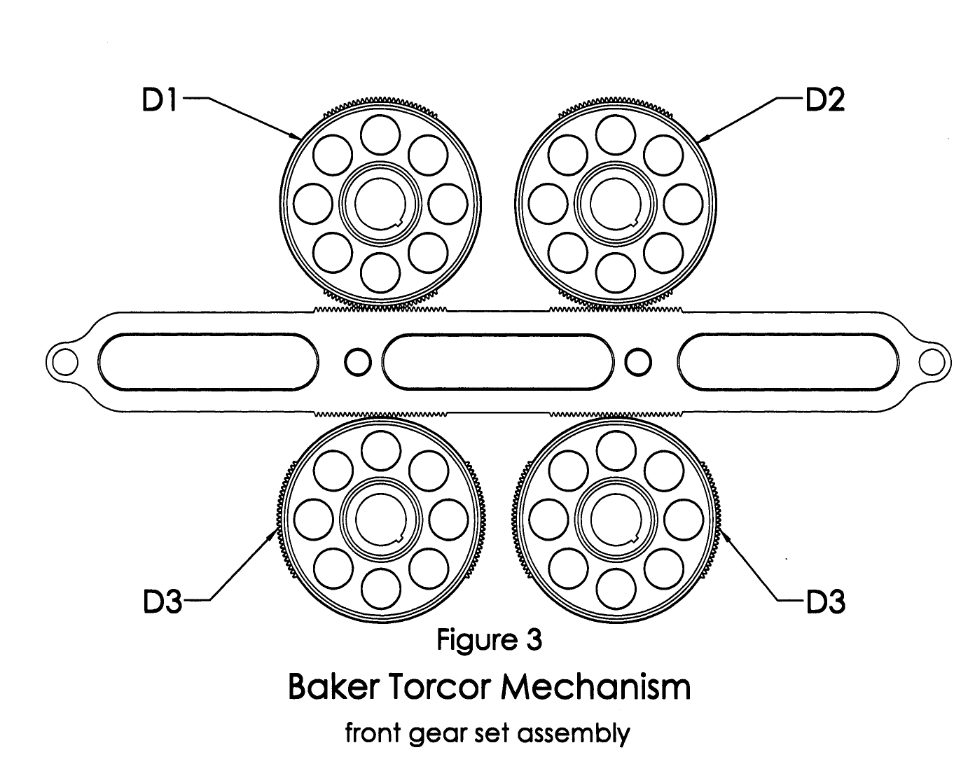

Referring to FIG. 3, gears D1, D2, D3, and D4 are the interrupted gears and are parts of the front gear set. gear D1, D2, D3, and D4 may have any number of timed and interrupted teeth at intervals spaced to meet the stroke requirements of rack E. Interrupted gears D1, D2, D3, and D4 are straight cut external spur gears which all may be rotationally meshed to rack E in a timed and alternating fashion.

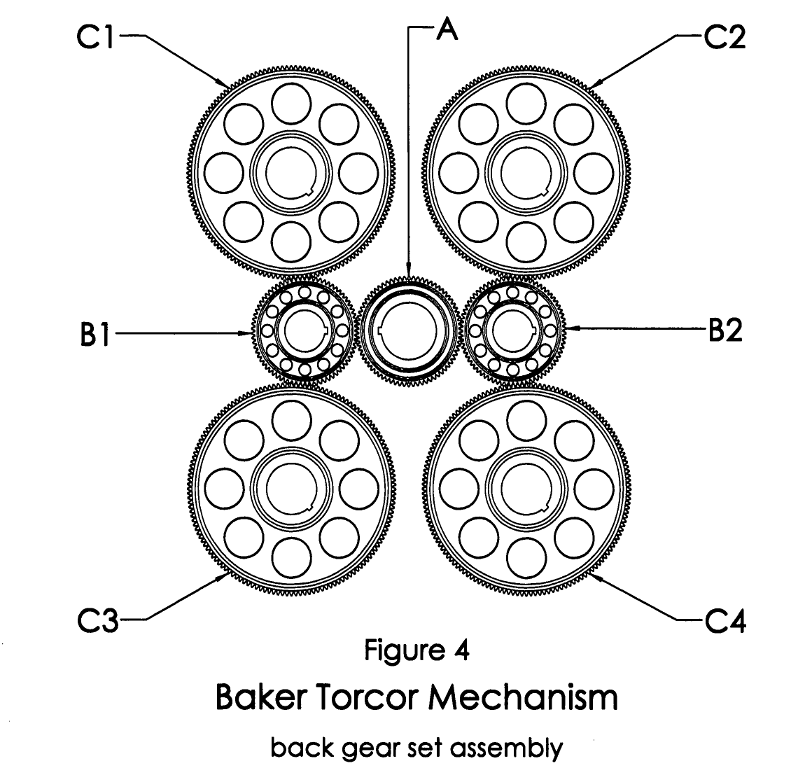

Gear D1 may share a common shaft and be rotationally connected to intermediate gear C1 (shown in FIG. 4). Gear D2 may share a common shaft and be rotationally connected to intermediate gear C2 (shown in FIG. 4). Gear D3 may share a common shaft and be rotationally connected to intermediate gear C3 (shown in FIG. 4). Gear D4 may share a common shaft and be rotationally connected to intermediate gear C4 (shown in FIG. 4). Gears D1, D2, D3, and D4 may be supported by bearings and may be of any size or thickness depending on load and have any number of teeth dependent on final drive or under drive ratios required. Gears D1 and D2 alternate mesh positions with gears D3 and D4 in their rotational connection with Rack E, as described below.

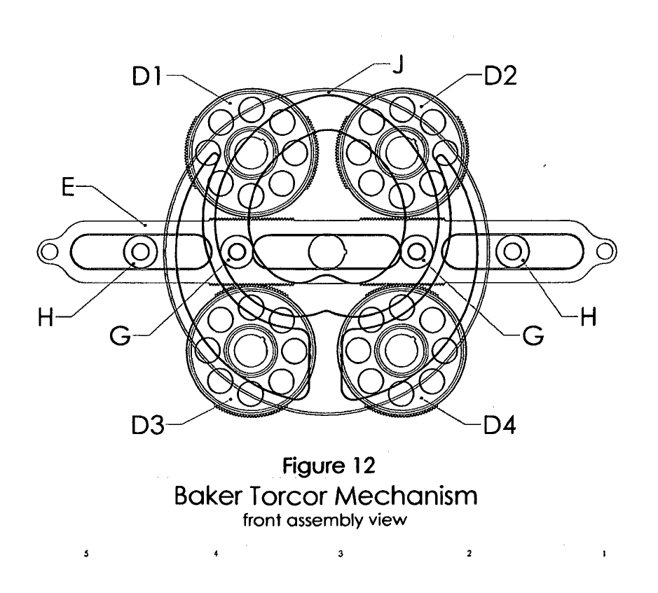

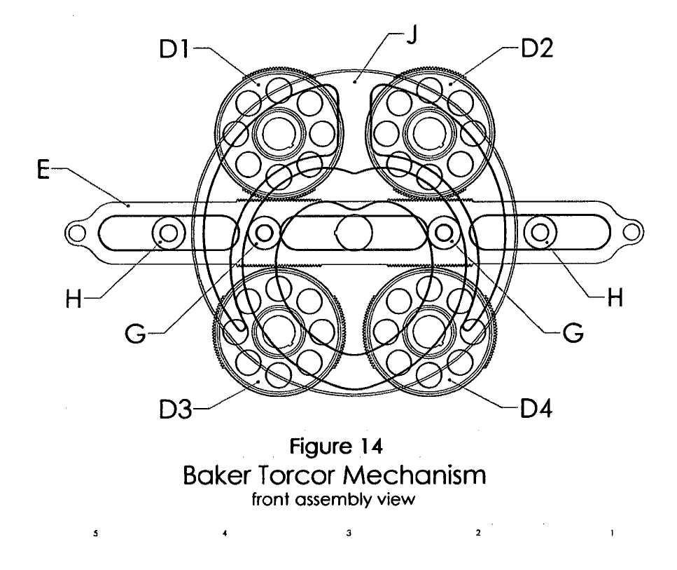

In a rotary to linear conversion, Gear D1 is driven by gear C1, gear D2 is driven by gear C2 and, in a timed fashion, gears D1 and D2 drive Rack E to the right (as illustrated in FIG. 12) while gears D3 and D4 have their interrupted sections pass by Rack E's lower gears. Gear D3 is driven by gear C3, gear D4 is driven by gear C4, and, in a timed fashion, gears D3 and D4 drive Rack E to the left (as illustrated in FIG. 14) while gears D1 and D2 have their interrupted sections pass by Rack E's upper gears.

In a linear to rotary conversion, Gears D1, D2 and gears D3, and D4 are driven in a timed and alternating fashion by Rack E, wherein Rack E's linear motion to the right (as illustrated in FIG. 12) drives gears D3 and D4 in a clockwise rotation. Rack E's linear motion to the left (as illustrated in FIG. 14) drives gears D1 and D2, also in a clockwise rotation. Note gears D1, D2, D3 and D4 drive gears C1, C2, C3, and C4 in a clockwise rotation.

Still referring to FIG. 3, rack gear E is the linear rack and is part of the front gear set. Rack E is a straight cut external spur gear which has 4 sets of teeth, all of which may be meshed to rotating interrupted gears D1, D2, D3, and D4 in a timed and alternating fashion. Rack gear E may have any amount of teeth dependent on stroke requirements and may be located on the outside of the rack.

Rack gear E's linear track and dimensional mesh tolerance retention between Rack gear E and gears D1, D2, D3 and D4 is provided by a guide (generally indicated as H) which may be a bearing or similar device. Rack gear E is further guided by additional wear surfaces or bearings (not shown in drawings) to resist fore and aft movement. Two rack-to-flywheel alignment and tracking mechanisms (generally indicated as G) are mounted on and protrude from the outboard face of Rack gear E. Rack gear E may be designed with an assortment of end components to attach to differing drive or driven components, such as pistons for an internal combustion engine.

In a rotary to linear conversion, gears D1 and D2 drive rack E to the right (as illustrated in FIG. 12) in a timed fashion as gears D3 and D4 have their interrupted sections pass by rack E's lower gears. Then, after gears D1 and D2 have passed their mesh with rack E, and aided by flywheel J, gears D3 and D4 mesh and drive Rack E to the left (as illustrated in FIG. 14) while gears D1 and D2 have their interrupted sections pass by rack E's upper gears.

In a linear to rotary conversion, rack E's linear motion to the right (as illustrated in FIG. 12) drives gears D3 and D4 in a clockwise rotation. Rack E's linear motion to the left (as illustrated in FIG. 14) drives gears D1 and D2, also in a clockwise rotation. Accordingly, gears D1, D2, D3 and D4 drive gears C1, C2, C3, and C4 in a clockwise rotation.

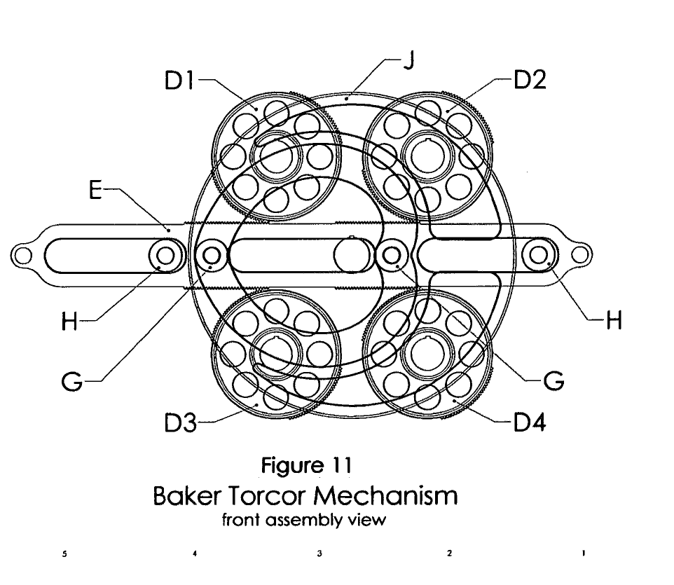

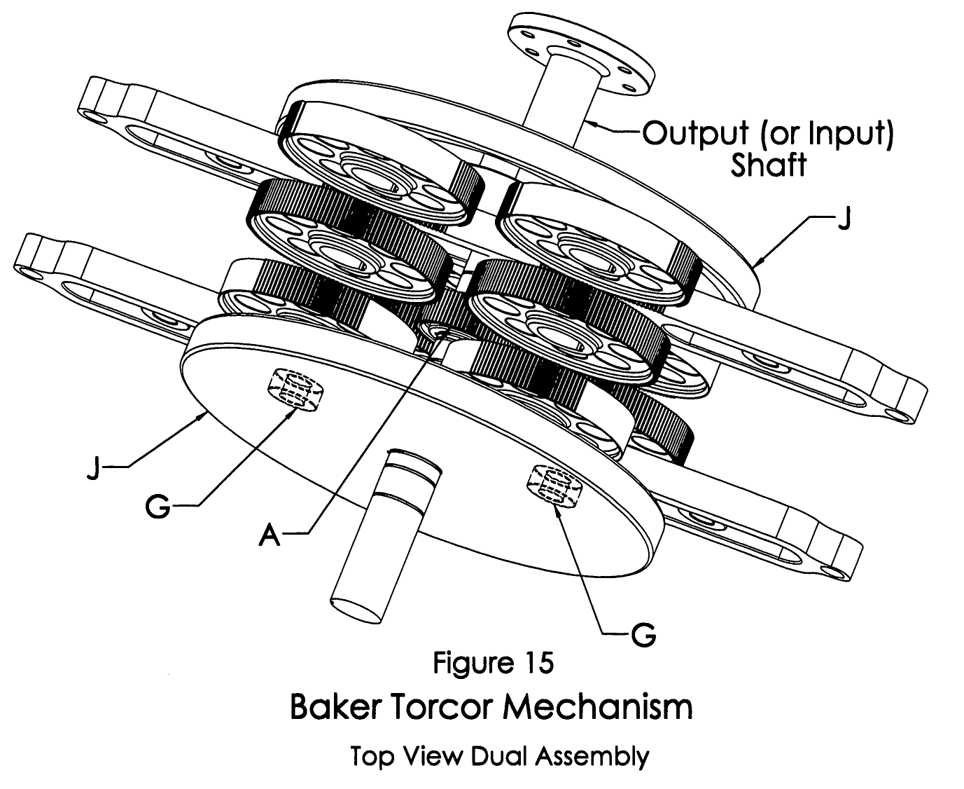

Referring to FIG. 4, Gear A is the center shaft gear and is part of the back gear set. Gear A is a straight cut external spur gear which may be rotationally meshed to Gears B1 and B2. Rotationally connected to Gear A is the center shaft which either transmits or receives rotational energy. Gear A may be of any size or thickness depending on load and have any number of teeth dependent on final drive or under drive ratios required. Gear A shares its shaft, and is indexed with, flywheel J in a timed manner (as shown in FIGS. 11, 12, 13 and 14 and duplicated in FIG. 15).

In a rotary to linear conversion, Gear A is driven by rotational input energy and drives Gears B1 and B2. In a linear to rotary conversion, Gear A is driven by Gears B1 and B2. Gear A is meshed with Gears B1 and B2 in a timed manner.

Still referring to FIG. 4, Gears B1 and B2 are the center mesh gears and are parts of the back gear set. Gears B1 and B2 are straight cut external spur gears which are rotationally meshed to the center shaft gear A. Gear B1 is rotationally meshed to Gear A and Gears C1 and C3, Gear B2 is rotationally meshed to Gear A and Gears C2 and C4, and both Gears B1 and B2 may rotate on stationary shafts which may be supported by bearings. Gears B1 and B2 may be of any size or thickness depending on load and have any number of teeth dependent on final drive or under drive ratios required.

In a rotary to linear conversion, Gears B1 and B2 are driven by center shaft gear A1, and Gear B1 drives intermediate Gears C1 and C3 while Gear B2 drives intermediate Gears C2 and C4. In a linear to rotary conversion, Gear B1 is driven by intermediate Gears C1 and C3 while B2 is driven by intermediate Gears C2 and C4. Gears B1 and B2 are meshed with Gear A and Gears C1, C2, C3, and C4 in a timed manner.

Still referring to FIG. 4, Gears C1, C2, C3, and C4 are the intermediate back gears (as viewed from front of input shaft) and are parts of the back gear set. Intermediate Gears C1 and C3 are straight cut external spur gears which may be rotationally meshed to gear B1. Gear C1 may share a common shaft and be rotationally connected to interrupted gear D1 (shown in FIG. 3). Gear C3 may share a common shaft and be rotationally connected to interrupted gear D3 (shown in FIG. 3). Intermediate Gears C2 and C4 are straight cut external spur gears which may be rotationally meshed to the gear B2. Gear C2 may share a common shaft and be rotationally connected to interrupted gear D2 (shown in FIG. 3). Gear C4 may share a common shaft and be rotationally connected to interrupted gear D4 (shown in FIG. 3). Gears C1, C2, C3, and C4 may be supported by bearings and may be of any size or thickness depending on load and have any number of teeth dependent on final drive or under drive ratios required.

In a rotary to linear conversion, Gears C1 and C3 are driven by Gear B1 and Gears C2 and C4 are driven by Gear B2. Gear C1 drives Gear D1 and Gear C3 drives Gear D3 while Gear C2 drives gear D2 and Gear C4 drives gear D4.

In a linear to rotary conversion, Gear C1 is driven by gear D1, gear C3 is driven by gear D3 and, in a timed and alternating fashion, gears D1 and D3 drive gear B1. Gear C2 is driven by gear D2, gear C4 is driven by gear D4, and, in a timed and alternating fashion, gears D2 and D4 drive gear B2.

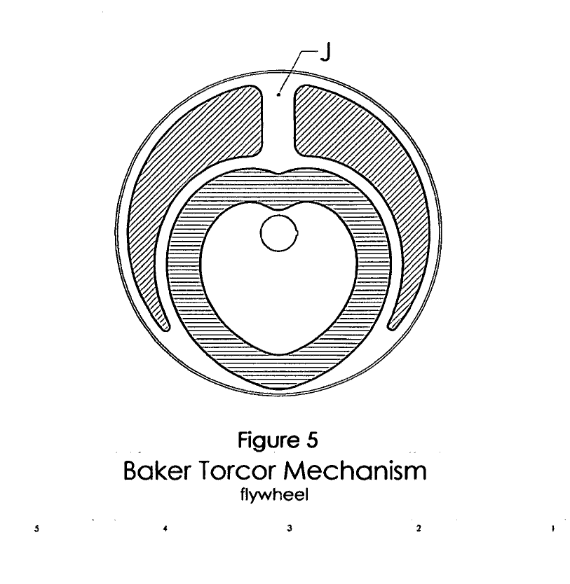

Now referring to FIGS. 11, 12, 13 and 14 and duplicated in FIG. 15, flywheel J (FIG. 5) is rotationally connected to the center shaft. Flywheel J is rotationally connected to, and indexed with gear A in a timed manner. Flywheel J is primarily responsible for changing the direction of rack gear E at the end of the rack gears linear stroke to the left or right after gears D1 and D2 and then D3 and D4 have alternating become engaged and disengaged respectively.

Two rack-to-flywheel alignment roller bearings generally indicated as G (in FIGS. 11, 12, 13 and 14 and 15) are mounted on the outboard face of rack gear E and are spaced to seat in and follow the grooved heart shaped track in flywheel J. By following the track in Flywheel J, these bearings provide the connective and corrective force for changing the linear direction of rack gear E at the end of its stroke to the left or right after gears D1 and D2 and then D3 and D4 have become engaged and disengaged respectively in a timed and alternating fashion.

In operation, and assuming the input energy is linear (such as an ICE) and the flywheel rotation is clockwise, FIG. 11 shows a starting point wherein the rack is situated fully to the left. Gears D1, D2, D3, and D4 rotate in the same direction as the flywheel (clockwise). The teeth on gears D1, D2, D3, and D4 are disengaged from rack gear F at this point. Movement of rack gear E is controlled by roller bearings G and heart shaped groove in flywheel J. As flywheel J rotates (FIG. 12), roller bearings G drive rack gear E to the right.

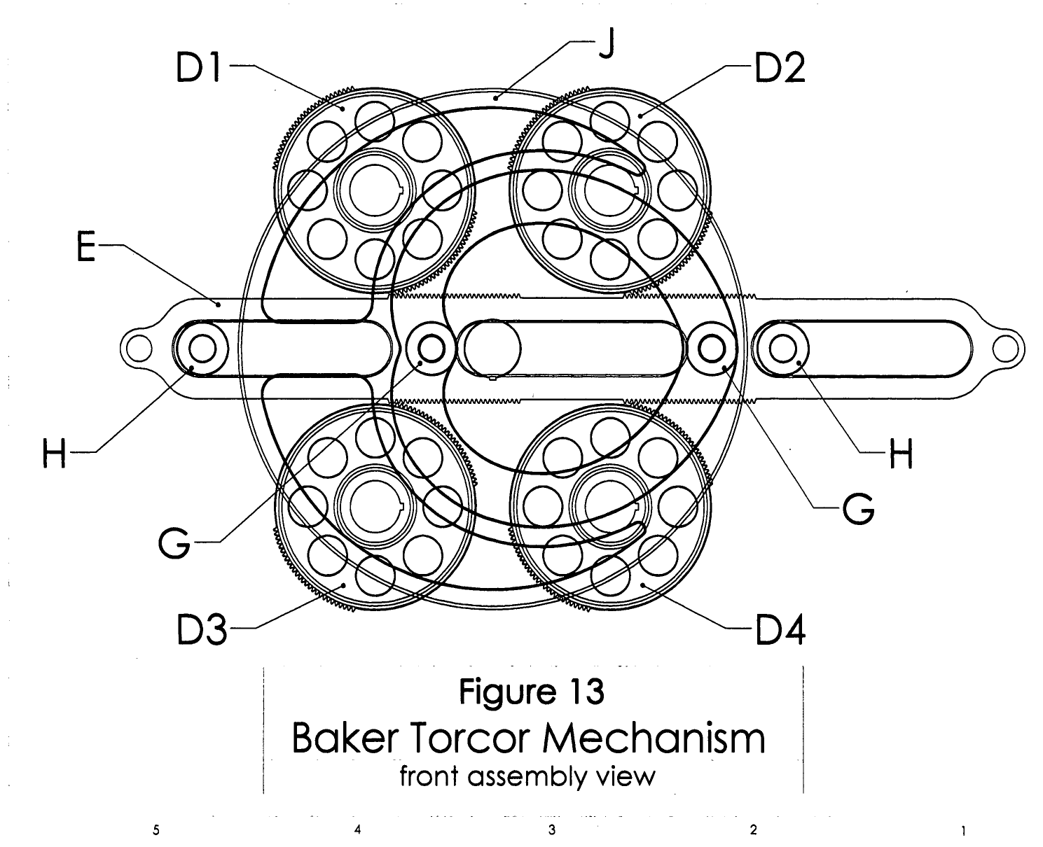

After roller bearing G follows its path in the flywheel groove a slight amount, the teeth in Gears D3 and D4 engage with rack gear E and continue to drive rack E to the right. Gears D1 and D2 are rotating clockwise, but the teeth on gears D1 and D2 are not engaged at this point (as no teeth exist on gears D1 and D2 in this area.) As rack gear E approaches the full right travel limit (FIG. 13), the gears D3 and D4 disengage from the rack gear E. Roller bearings G follows the groove in flywheel E and finishes the racks travel to the right. Once again, the bearings G take over the job of rack gear E positioning.

At the end of the right hand travel, rack gear E starts to move to the left (FIG. 14), guided by roller bearings G. After the rack gear E moves a slight amount, the teeth in gears D1 and D2 engage with rack gear E and continue to drive the rack to the left. Gears D3 and D4 are rotating clockwise, but the teeth on gears D3 and D4 are not engaged at this point (as no teeth exist on gears D3 and D4 in this area.) As rack gear E approaches the end of the left hand travel, gears D1 and D2 disengage from rack gear E. Once again, roller bearing G follows the groove track in flywheel J and starts the process over again.

Since front gears D1, D2, D3, and D4 are rotationally connected and locked with back gears C1, C2, C3, and C4, the front gears drive the back gears, which rotate the center mesh gears and finally rotate the center gear, which allows energy to be taken from the center gears rotationally connected and locked center shaft (in the case of linear to rotary conversion). Obviously, the exact opposite is the case for rotary to linear conversion.

In the preferred embodiment, the present invention converts a pistons linear motion to a rotary output using uniquely timed gears, connecting rod(s) and flywheel(s) to accomplish a four stroke combustion process without a crankshaft. In the Baker Torcor mechanism four-stroke ICE, there are four distinct operational steps, each performed in sequence; the intake stroke, the compression stroke, the combustion or power stroke and finally the exhaust stroke.

The intake stroke introduces combustible fuel into a closed combustion chamber; the compression stroke pressurizes the air/fuel mix in the combustion chamber; the combustion stroke or power stroke ignites the pressurized gasses and the expanding gasses exert a force upon the piston, and the exhaust stroke, where the burned and cooled gasses are exhausted to atmosphere. The Baker Torcor mechanism easily adapts to existing and well understood ICE theory and operation.

This Otto based four stroke cycle is greatly improved and optimized by the present invention wherein the angular relationship between the drive member (the linear motion of the piston) and the driven member (the rotating interrupted front gear) achieves and maintains the mechanical and mathematically optimum ninety (90) degree vector angle throughout the travel of the linear component.

In the ICE embodiment, the present invention provides the means to achieve a constant and optimum ninety degree relationship between the linear motion of the piston and the rotary motion of the output shaft during the entire combustion and exothermic expansion cycle of the air/fuel mixture. This attribute optimizes mechanical efficiencies, providing maximum torque at a relatively low and steady rpm.

When compared to a traditional ICE engine and its counterproductive Before Top Dead Center (BTDC) ignition timing points (the igniting of the compressed air/fuel mixture with spark plugs), and all of the previously described problems associated with said ignition timing, the present inventions ignition timing point will be shortly After Top Dead Center (ATDC) at the beginning of the power stroke, thereby utilizing the entire combustion process to convert energy to rotary work output with a highly efficient mechanical advantage.

Faster burning fuels will be able to be used without the problems of detonation as is common with standard crankshaft ICE's. Camshaft design may change to less than 180 degrees of main output shaft rotation for both the intake and exhaust valve events, with 0 degrees of overlap, providing an ultra clean burn ICE.

Much smaller and lighter engine packages will be required to make the same torque output as a comparable standard crankshaft ICE. Energy savings will be substantial, not only because of smaller packages, but also because of the optimized energy transfer obtained with the present invention. The same benefits are realized in two stroke ICE machines and external combustion engines.

The present invention is a clear improvement over existing motion conversion mechanisms and achieves increased efficiency over traditional crankshaft based engines by the mechanical functionality as described in the description of operation herein. Scaled up or down in physical and volumetric size and/or number of linear point or rotary point inputs and/or outputs, the present invention can provide great improvements to the state of the art in any applicable use and implementation.

### Second Embodiment

In a second embodiment of the present invention, operating as described but without the fuel delivery and ignition system components required for an ICE application, would prove to be of superior design and efficiency when applied to pneumatic systems. By utilizing the mechanism described herein, the conversion of a rotary motion to a linear motion is optimized and the linear pumping device achieves and maintains the mathematically optimum ninety degree angle throughout the linear components travel.

As rotary input motion drives the center gear, center mesh gears, intermediate gears and then the interrupted front gears, the linear motion of the rack and attached pumping pistons, devices or apparatus achieves increased efficiency over traditional crankshaft based air compressors. The inverse operation provides the means for similar functionality and operational efficiency when applied to air driven motors.

### Third Embodiment

In a third embodiment, the present invention, operating as described but without the fuel delivery and ignition system components required for an ICE application, would prove to be of superior design and efficiency when applied to piston hydraulic machines, such as pumping devices.

As rotary input motion drives the center gear, center mesh gears, intermediate gears and then the interrupted front gears, the linear motion of the rack and attached hydraulic pumping pistons, devices or apparatus achieves increased efficiency over traditional crankshaft based hydraulic pumps by the mechanical functionality as described in the description of operation herein. The inverse operation provides the means for similar functionality and operational efficiency when applied to hydraulic motors.

### Forth Embodiment

In a fourth embodiment, the present invention, operating as described but without the fuel delivery and ignition system components required for an ICE application, would prove to be of superior design and efficiency when applied to rotary and/or linear induction of magnetic fields and the means to provide electrical energy production.

As rotary input motion drives the center gear, center mesh gears, intermediate gears and then the interrupted front gears, the linear motion of the rack and attached magnetic and/or electromagnetic device or apparatus move within a device or apparatus that provides the counterforce of magnetic and/or electromagnetic fields that allow for linear electrical generation. The exact opposite is true for electric motor operation.

### Fifth Embodiment

In a fifth embodiment, the “stacking” or combining of the present invention of different embodiments may include a combination of functions, all utilizing the benefits and operational modalities described herein, and all may or may not share a common center shaft or linear point. For example, an ICE application of the present invention may share a common center shaft or common rack, which may be of a solid and fixed or intermittent/clutched connection, and may operate another embodiment of the present invention, wherein the second attached mechanism is an air compressor or an electrical generator.

Additionally, there may be three or more different devices, all sharing the same basic mechanism, connected in series or parallel, wherein one mechanism is an ICE, the second is an air compressor, the third is an electrical generator, and perhaps a fourth is a hydraulic pump.

Still further, rotary or linear electric motor embodiment may operate a hydraulic pump embodiment or an air compressor embodiment. The exact opposite is also an available and useful combination. And of course, the attachment points may share a common center shaft or one or more linear connection points.

### Sixth Embodiment

In a sixth embodiment, the device may provide improved human and/or animal powered mechanized devices, such as bicycles and all variants thereof, grinding devices, lifting devices, pushing and/or pulling mechanisms, pumps and many others which may become possible after implementing the present invention in mechanisms and/or devices.

### Seventh Embodiment

In a seventh embodiment, the present invention may provide for an improved means to operate robotic systems and/or subsystems. Providing a more efficient mechanized energy transfer system allows for reduced energy consumption, which is of particular and paramount importance to standalone robotic systems, as they are by definition not tethered to an energy supply and therefore must carry all of their energy on board.

Further, robotic functions, movements and articulations may be enhanced, improved or introduced using the present invention. These improvements may provide for a more energy efficient robotic system and/or subsystem which may be superior to the current state of the art, and therefore of significant importance and value.

### Eighth Embodiment

In an eighth embodiment, medical system and device applications may be improved by providing increased efficiency through reduced energy consumption, allowing for reduced size and decreased cost with increased service life.

For example, an artificial heart may be possible using the present invention wherein the linear stroke could provide the pumping action and the required rotary input energy may be reduced due to the favorable ratios between the rotary and the linear movements. Of course, the same may be said for the inverse wherein the artificial heart may utilize a linear energy input causing a rotary pumping action, and/or any combination thereof.

Medical uses such as kidney dialysis machines, oxygen pumps, artificial limbs and other prosthetic devices, direct (or indirect) replacement joints and/or limbs, surgical devices, rehabilitation machines and other medical equipment is also possible and may be improved by providing increased efficiency through reduced energy consumption, allowing for reduced size and decreased cost with increased service life.

### Ninth Embodiment

In a ninth embodiment, the present invention may be used in the nano scale, providing high efficiency energy transfer using the attributes of the present invention, but having the teeth of the gears and rack replaced with atoms and/or strings of atoms, and said atoms or strings of atoms provide the connective and motive force between driving and driven members to achieve the desired mechanical energy transfer described herein.

An example may include nano scale mechanisms that provide a mechanical link between nano scale devices such as nano scale electric motors and nano scale pumping devices.

### Tenth Embodiment

In a tenth embodiment, the present invention may be used in aircraft control surface applications, landing gears and systems, spacecraft control and guidance systems, rockets, UAV's and other known and unknown control, guidance and propulsion systems.

### SUMMARY

By invention and intentional design, the high efficiency of the present invention, commonly known as the Baker Torcor mechanism, is attributed to energy being transmitted at the mechanically and mathematically optimum ninety degree vector angle during the entire travel of the linear stroke and/or rotation. The movement of the drive component (linear or rotary) results in an exact mathematical movement of the driven component (rotary or linear), divided by or multiplied by its gear ratio and can be measured at any point of the stroke or angle of rotation, and said ratios may be changed to match virtually any requirement and/or demand in any and all applications within which the present invention may be utilized.

As a result of the operating characteristics of the present invention, mechanical motion conversion efficiencies are increased, material and manufacturing cost and physical size and area per pound foot of torque produced decreased, production is simplified, operating speeds are reduced which decreases wear and increase service life. Torque and speed changes are easily achieved by conventional means.

In addition, the present invention will dramatically reduce piston skirt, piston ring and cylinder wall wear due to the virtual elimination of linear stroke side loading, as experienced in a crankshaft based motion conversion mechanisms such as the ICE.

It is well understood to anyone skilled in the art that the present invention is unique and has a specific purpose and advantage over the current state of the art, and that the mechanism itself may be used in countless applications and on any scale, where one type of motion needs to be converted into another more efficiently, including, but not limited to, bicycles, engines, wind turbines, electrical generators and motors, hydraulic pumps/motors, wave energy capture, etc.

What is claimed:

1. A motion conversion mechanism which may consist of timed gears and flywheel or flywheels to convert a linear motion into a rotary motion or a rotary motion into a linear motion with a set stroke (or an adjustable stroke in an adjustable stroke embodiment) of rotation in a positive, constant rate and square torque advantage fashion wherein the linear motion is automatically reversed at the end of its stroke, the stroke length may be determined by the diameter and ratio of the rotating gears, the movement of the drive component (linear or rotary) results in an exact mathematical movement of the driven component (rotary or linear) divided by or multiplied by its gear ratio and can be measured at any point of the stroke or angle of rotation, and the mathematically and mechanically optimum ninety degree torque arm may be achieved for at least a timed period of the travel of the linear and/or the rotation of the rotary.

2. The mechanism of claim one (1) which has at least one sliding member (rack) which may have geared teeth of a specific size and count on at least one linear sides that may be in a parallel relationship to at least two fixed position, rotating circular gears, wherein said gears may have an interrupted group of teeth of a specific size and count, spaced at intervals to meet the stroke requirement of the rack and are situated to permit timed engagement of the rotating circular gears and the sliding geared rack during at least a timed portion of the linear stroke of the geared rack to provide a constant ninety (90) degree vector angle between the sliding rack and the fixed position rotating circular gear(s).

3. The mechanism of claim two (2) which may, through a length of shaft or other interconnecting device, rotationally connect the fixed position rotating circular gears which may have an interrupted group of teeth of a specific size and count, to the fixed position rotating circular gears which may have geared teeth of a specific size and count around the entire circumference to permit rotational torque transfer between the two rotating gears and provide an uninterrupted geared path to transmit torque to another component.

4. The mechanism of claim three (3) which may have center mesh gears and which may have geared teeth of a specific size and count around the entire circumference to permit rotational torque transfer between the rotating circular gears, which may have geared teeth of a specific size and count around the entire circumference of claim three (3), and a center input/output gear which may have geared teeth of a specific size and count around the entire circumference to permit rotational torque transfer between the two rotating meshed gears and provide an uninterrupted geared path to transmit torque to an input/output shaft rotationally connected to said center input/output gear, wherein said input/output shaft may import or export rotational torque dependant on input energy being linear or rotary. Said gears may be any number and size to match the requirements of the work to be done.

5. The mechanism of claim four (4) wherein a flywheel is rotationally connected to at least one end of the input/output shaft. Said flywheel may have a slot or groove in at least one side which is of a sufficient depth to permit a bearing or other similar tracking device which may be attached to a fixed position on the rack to follow the track of the groove to provide the linear reversal of the racks direction, motion stabilization and torque transfer, or any other mechanical, electrical, hydraulic, pneumatic and/or other apparatus or sets of mechanical, hydraulic, pneumatic and/or other apparatus which may provide the means for linear track reversal.

6. The mechanism of claim five (5) wherein the rack may have geared teeth, friction material or other connection devices of a specific size, type and/or count on any side and may be in a parallel relationship to at least two fixed position, rotating circular gears which may be situated above, below or next to each other, connected to the rack and may have an interrupted group of teeth, friction material or other connection devices of a specific size and/or count spaced at intervals to meet the stroke requirement of the rack that are situated in any means to permit timed engagement of the rotating circular gears and the sliding geared rack during at least a timed portion of the geared racks linear stroke to provide a ninety (90) degree vector angle.

7. The mechanism of claim six (6) wherein said flywheel is rotationally connected to at least one end of the input/output shaft and may, on at least one face, have a groove, raised surface or any other three dimensional surface wherein said groove, raised surface or any other three dimensional surface is employed to accomplish the task of providing the linear reversal of the racks direction, motion stabilization and torque transfer and/or any mechanical, electrical, hydraulic, pneumatic and/or other device and/or apparatus or sets of mechanical, electrical, hydraulic, pneumatic and/or other device or apparatus provides the means for the linear reversal of the racks direction, motion stabilization and torque transfer.

8. The mechanism of claim seven (7) wherein the flywheel(s), the input/output gear, the center mesh gears, the fixed position rotating circular gears which may have geared teeth, friction material or other connection devices of a specific size and/or count around the entire circumference and the fixed position rotating circular gears which may have an interrupted group of teeth, friction material or other connection devices of a specific size and/or count spaced at intervals to meet the stroke requirement of the rack that are situated in any position relative to each other which provides the means of timed engagement of the rotating circular gears and the sliding geared rack during at least a timed portion of the linear stroke of the geared rack to provide a constant ninety (90) degree vector angle between the sliding rack and the fixed position rotating circular gear(s).

9. The mechanism of claim one (1) wherein any component of the mechanism may be situated remotely and connected to any other portion of the mechanism or component of the mechanism through any means including hydraulic, pneumatic or mechanical devices such as hoses, gears, levers or cables, with the result of providing the means of timed engagement of the rotating circular gears and the sliding geared rack during at least a timed portion of the linear stroke of the geared rack to provide a constant ninety (90) degree vector angle between the sliding rack and the fixed position rotating circular gear(s).

10. The mechanism of claim one (1) wherein the ends of the rack are attached to pistons or any other device(s) attached to the ends of the rack which may slide in a bore or other appropriate suitable apparatus to achieve the desired result to create the basis for an internal or external combustion engine or an air compressor, where the input energy is rotational and the output energy is linear, or, conversely, an air motor or similar air operated device, where the input energy is linear and the output energy is rotational or any deviation of rotary, such as orbital.

11. The mechanism of claim one (1) wherein the ends of the rack are attached to pistons or rotary devices which slide in or operate in a bore or any other device attached to the ends of the rack to create the basis for a hydraulic pump and/or motor where the hydraulic pump input energy is rotational and the output energy is linear and the hydraulic motor input energy is linear and the output energy is rotational.

12. The mechanism of claim one (1) wherein the ends of the rack are attached to electrical, magnetic or electromagnetic components or devices which enables, through linear and/or rotary induction of magnetic fields, the means to provide electrical energy production.

13. The mechanism of claim one (1) wherein the number of mechanisms may be combined to produce multi function devices such as a two cylinder engine with a two cylinder air compressor, a two cylinder engine with a one cylinder air compressor and a one cylinder hydraulic pump, a two cylinder hydraulic motor with a two cylinder air compressor, and/or any number and combination of the mechanism for any single or multi use system.

14. The mechanism of claim one (1) wherein the rack is any shape other than flat and level, such as square, rectangular, round, an arc or circle, or any physical dimension or length, such as continuous or in sections with the result of providing the means of timed engagement of the rotating circular gears and the sliding geared rack during at least a timed portion of the linear stroke or rotation of the geared rack to provide a constant ninety (90) degree vector angle between the sliding rack and the fixed position rotating circular gear(s).

15. The mechanism of claim one (1) wherein multiple rotating front or rear (or center) gear assemblies comprising any number of gears are driving at least one rack of any shape (as previously defined in claim 14) and/or multiple racks of any shape (as previously defined in claim 14) driving at least one front and/or rear (or center) gear assembly, so increased or decrease torque and speed may be obtained.

16. The mechanism of claim one (1) wherein rotational or linear energy and motion is taken from or added to any rotary or linear component in any amount to provide power take off or drive assist functionality to the mechanism.

17. The mechanism of claim one (1) wherein gears may be straight cut external spur gear, internal cut spur gear, bevel cut gear (straight, helical, or curved), epicyclical gearing (straight or helical gearing), worm gear or made from any type of friction materials, or any other known or unknown method of physical component interaction to cause movement of one item to another, and the gears may be splined, keyed, locked, welded, fused bolted, machined or attached by any other means to a shaft and said gears and interconnecting devices may rotate on bearings.

18. The mechanism of claim one (1) wherein at least a second assembly of front gears and rack(s) that may be attached to the back side of the back gear set to create a four linear point mechanism or wherein the back gear set becomes a shared center gear set, enabling power and torque increases or utilization of other means with fewer components against simply using two complete mechanisms.

19. The mechanism of claim one (1) wherein the size of the components are produced at or in any scale or size, from nano machines to industrial giants, for any use, including but not limited to, two and four stroke internal combustion engines, air compressors and motors, hydraulic pumps, motors or other hydraulic devices of any fluid or viscosity, electric motors, generators and any other rotary or linear magnetic field induction device or apparatus, stamping machines, presses, cutters and other mechanical advantage device for manufacturing and production, lifting, pulling and pushing devices or apparatus, bicycles and other human powered devices, geologic oil and gas exploration and pumping such as exploration drills and oil pumping derricks, tidal and wave energy conversion devices, wind energy conversion devices, excavators, bull dozers, or other mechanical advantage devices for mining and earth moving, and any other device which may benefit from the attributes of the present invention.

20. The mechanism of claim one (1) wherein mechanical, electrical, hydraulic, pneumatic and/or other connect/disconnecting device and/or apparatus or sets of mechanical, hydraulic, pneumatic and/or other connect/disconnecting device and/or apparatus provides the means for engaging and/or disengaging mechanical, hydraulic, pneumatic and/or other device and/or apparatus, or sets of mechanical, hydraulic, pneumatic and/or other device and/or apparatus to enable ratio changing functionality through manual or automatic means, such as physically and manually changing components to change a given ratio between components, the physical and automatic changing of components with mechanical, electrical, hydraulic, pneumatic and/or other device and/or apparatus, or sets of mechanical, electrical, hydraulic, pneumatic and/or other device and/or apparatus using a lever and/or control device such as a shift lever and/or a synchronized sliding gear rail and/or a clutch assembly, or the physical and fully automatic changing of components with mechanical, electrical, hydraulic, pneumatic and/or other device and/or apparatus, or sets of mechanical, electrical, hydraulic, pneumatic and/or other device and/or apparatus which may enable physical and automatic changes in the components sited herein to achieve any ratio between any drive and driven component, its physical relationship to any other component and/or its purpose and/or function as cited in the present invention.
